(19) United States
(12) Patent Application Publication
(10) Pub. No.: US 2026/0141349 A1
(43) Pub. Date: May 21, 2026

(54) WEB BROWSER WITH INTELLIGENT PROJECT MANAGEMENT INTEGRATION

(71) Applicant: Microsoft Technology Licensing, LLC, Redmond, WA (US)

(72) Inventor: Mrinal Kumar SHARMA, Noida (IN)

(73) Assignee: Microsoft Technology Licensing, LLC, Redmond, WA (US)

(21) Appl. No.: 18/951,154

(22) Filed: Nov. 18, 2024

(51) Int. Cl. G06Q 10/10; G06F 18/241

(52) U.S. Cl. CPC G06Q 10/103; G06F 18/241

(57) ABSTRACT

A project management system for a browser application utilizes extracts text from application content loaded into view ports of the browser application and generates a prompt for a generative artificial intelligence (AI) model that includes the extracted text. The model is trained to generate an urgency level classification for the application content based on the extracted text. The project management system receives the urgency level classifications for the application content and causes the tabs of the view ports in which the application content is loaded to be depicted in a manner that is indicative of the urgency level classification of the associated application content.

### BACKGROUND

Web browsers are widely used to perform project management tasks because they enable multiple documents and web applications to be loaded into different tabs so they can be accessed within a single application. However, aggregating multiple documents and web applications into the same application window can introduce inefficiencies in the performance of project management tasks due to the lack of visual cues which can be used to identify the project that a tab is associated with or the urgency/importance of projects associated with a tab. Consequently, users often have to spend considerable amounts of time switching from tab to tab to locate a desired document or find relevant information pertaining to a project. Previously known web browsers in general do not have features which can facilitate project management.

Hence, what is needed is a project management system which can be integrated into web browsers to enable project and timeline information of the projects associated with the browser tabs to be identified without requiring frequent context switching between tabs and that otherwise enhance the ability of web browsers to perform project management tasks.

### SUMMARY

In one general aspect, the instant disclosure presents a data processing system having a processor and a memory in communication with the processor wherein the memory stores executable instructions that, when executed by the processor alone or in combination with other processors, cause the data processing system to perform multiple functions. The functions include extracting text from application content loaded into view ports of a browser application, the browser application including a tab for each of the view ports; generating a prompt for urgency level classification model, the urgency level classification model including a generative artificial intelligence (AI) model trained to receive the extracted text from the application content as input and to generate an urgency level classification for the application content based on the extracted text; receiving the urgency level classification from the urgency level classification model; generating snapshot information for the application content; providing the urgency level classification and the snapshot information to the browser application; and modifying a depiction of each tab of the browser application in a manner indicative of the urgency level classification for the application content loaded into the view port associated with the tab.

In yet another general aspect, the instant disclosure presents a method for facilitating performance of project management tasks utilizing a browser application. The method includes extracting text from application content loaded into view ports of a browser application, the browser application including a tab for each of the view ports; generating a prompt for urgency level classification model, the urgency level classification model including a generative artificial intelligence (AI) model trained to receive the extracted text from the application content as input and to generate an urgency level classification for the application content based on the extracted text; receiving the urgency level classification from the urgency level classification model; generating snapshot information for the application content; providing the urgency level classification and the snapshot information to the browser application; and modifying a depiction of each tab of the browser application in a manner indicative of the urgency level classification for the application content loaded into the view port associated with the tab.

In a further general aspect, the instant application describes a non-transitory computer readable medium on which are stored instructions that when executed cause a programmable device to perform functions of extracting text from application content loaded into view ports of a browser application, the browser application including a tab for each of the view ports; generating a prompt for urgency level classification model, the urgency level classification model including a generative artificial intelligence (AI) model trained to receive the extracted text from the application content as input and to generate an urgency level classification for the application content based on the extracted text; receiving the urgency level classification from the urgency level classification model; generating snapshot information for the application content; providing the urgency level classification and the snapshot information to the browser application; and modifying a depiction of each tab of the browser application in a manner indicative of the urgency level classification for the application content loaded into the view port associated with the tab.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 depicts an example computing environment upon which aspects of this disclosure may be implemented.

FIG. 2 depicts an example implementation of a user interface of a tabbed browser application into which project management features are integrated in accordance with this disclosure.

FIG. 3A depicts an example computing environment showing a browser application, a project management service, and a project management service client.

FIG. 3B shows an example implementation of a project identification and classification component of the project management service of FIG. 3A.

FIG. 4 shows an example user interface for a tabbed browser application showing visually distinct browser tabs based on project classifications and showing a project snapshot in accordance with this disclosure.

FIG. 5 shows another example user interface for a tabbed browser application showing visually distinct browser tabs based on project classifications and showing a project snapshot.

FIG. 6 shows an example user interface for a tabbed browser application showing a tab context menu with project management options in accordance with this disclosure.

FIG. 7 is a flowchart of a method of enabling a browser application to perform project management related tasks.

FIG. 8 is a block diagram illustrating an example software architecture, various portions of which may be used in conjunction with various hardware architectures herein described.

FIG. 9 is a block diagram illustrating components of an example machine configured to read instructions from a machine-readable medium and perform any of the features described herein.

### DETAILED DESCRIPTION

In large enterprises, employees across various roles such as engineers, designers, product managers, and analysts are involved in projects that are often complex, multi-faceted, and time-sensitive. These projects require collaboration across teams, adherence to deadlines, and efficient management of tasks and information. One challenge faced by such employees in enterprise settings is the seamless integration and effective management of project-related information across different tools and platforms. While project management tools and collaboration platforms provide essential functionalities for planning, scheduling, and communication, navigating between these tools and the web browser where extensive research, documentation, and communication occur can lead to inefficiencies and potential oversight of critical project timelines and tasks.

For example, project managers often utilize multiple different web applications to handle various project management tasks, such as communication apps (e.g., email, messaging, chatting, etc.) for communicating and collaborating with personnel, word processing apps for writing project plans and reports, presentation apps for creating presentations, note taking apps for taking notes during meetings and phone calls, spreadsheet apps for generating financial reports and project tracking, etc. Users may have all of the these apps and more open in different tabs of a web browser at the same time. However, due to the lack of differentiation between tabs, users often must spend considerable amounts of time searching through tabs to find a desired document or relevant information in one of the browser tabs.

Therefore, while web browsers facilitate multitasking by enabling multiple web pages, documents, and applications to be opened within a single application window, this aggregation of web pages, documents, and applications can introduce inefficiencies and reduce productivity in performing project and information management tasks. The inefficiencies and reduced productivity which can result from frequent context switching between project management applications and document repositories wastes computing resources and network bandwidth that could otherwise be used more productively. Therefore, while web browsers are widely used for project and information management tasks, the introduction of inefficiencies and reduced productivity is a technical problem that requires a technical solution.

To address these technical problems and more, in an example, this description provides technical solutions in the form of a project management system for browser applications which adds various features that facilitate and/or enhance the ability of a browser application to perform project management tasks and that minimize the need for frequent context switching between project management applications and document repositories. One feature provided by the project management tool is the use of artificial intelligence (AI) and/or machine learning (ML) models to automatically process application textual content (i.e., text, metadata, application-specific information, and the like) of the web pages opened in a browser application in order to automatically identify projects and/or project timelines associated with the application content and to extract information from the application content, such as due dates, deadlines, related tasks, related documents, etc., to use as the basis for classifying the urgency or importance of the project or timeline (e.g., high, medium, and low priority).

For the purposes of this disclosure, a browser application is a software application capable of retrieving and displaying content which may include web pages, web applications, local files, and the like (collectively referred to herein as a “web page” or “web pages.” The browser application loads content from a web page into a content window of the browser, also referred to as a view port. A view port defines the visible area of the web page which is loaded into the view port. The browser application enables multiple web pages to be loaded into different view ports in the browser application. One view port is typically shown in the main browser window at a time. The view port that is currently viewable in the main browser window is referred to herein as the “active” view port or “front” view port. View ports which are not currently viewable in the main browser window are referred to as “inactive” view ports or “background” view ports. The browser application includes a visible user interface control, such as a tab, associated with each of the respective view ports in the browser application which, when interacted with (e.g., clicked on), enable the corresponding view port to be switched to the active view port and made visible in the main browser window.

The project management system disclosed herein utilizes AI/ML techniques to automatically analyze the application content loaded into the view ports of the browser application in order to identify projects and/or project timelines associated with each view port and to classify the urgency level classifications (e.g., high urgency, moderate urgency, low urgency, etc.). The project management system then utilizes a predefined tab display scheme to modify the visual depiction of the tabs for the view ports in a way that is indicative of the urgency level classification of application content loaded in the view ports. In various implementations, a tab highlighting, or color-coding, scheme is used that involves assigning different colors to the different urgency level classifications and the causing all or a portion of each of the tabs to be displayed with the color that represents the urgency level classification for the application content loaded into the view port associated with the tab. For example, the colors red, yellow, and green can be assigned to high urgency, moderate urgency, and low urgency classifications, respectively. In this case, a tab associated with a view port having application content which has been classified as high urgency is displayed at least partially with a red color.

AI/ML models for the project management system can be trained to classify application content based on temporal and contextual information found in the application content, such as mentions of dates, durations, deadlines, milestones, and the like in connection with tasks, projects, assignments, etc. Application content which has been analyzed and determined to be related to a project or task which is due or scheduled to occur within a predefined high urgency period (e.g., three days, one week, two weeks, or the like) will be classified as high urgency. Similarly, a medium urgency period (e.g., due less than a month away) and a low urgency period (e.g., more than a month away, no due date, or the like) can be defined for the medium urgency and low urgency classifications, respectively. The AI/ML models for the project management system can be trained to analyze the application content to determine a timeline (e.g., due date, duration, deadline, milestones, etc.) for the application content. The determined timeline can then be used as the basis for selecting the color to be used for the tab associated with the view port in which the application content is loaded.

In some implementations, multiple colors and/or visual characteristics can be used in tabs to provide additional information pertaining to the project. For example, in some implementations, the AI/ML models can be used to analyze application content to identify a project type, e.g., writing assignment, presentation, financial report, project tracking, and the like, for the application content. Different colors can be assigned to different project types. A portion of each tab can then be used to depict the color indicating the project type associated with the application content.

The project management system also uses extracted project information to generate project snapshots for the application content associated with the browser view ports. A project snapshot is a pop-up window, dialog box, or other suitable type of user interface control which includes predetermined information pertaining to a project or timelines associated with the application content loaded into a view port in the browser application. For example, a project snapshot can list a project name, a document/application name, start date, due date, project urgency/importance classification, and the like and can include other elements, such as a progress tracker and controls for adding notes, indicating task completion, and the like. In various implementations, a project snapshot is displayed in response to detection of a mouseover, or hovering, event which occurs when a cursor or pointer associated with a user input device is positioned on a display screen over the area where a browser tab is displayed on the display screen for a predetermined amount of time without clicking on the tab. When a mouseover event is detected over a tab, the project snapshot for the view port associated with the tab is displayed adjacent the tab until the cursor or pointer is moved away from the tab. Project snapshots provide ways to access and interact with project information without having to open the tab in the browser window.

The project management system also provides a tab context menu with project management features which enables users to interact with application content and/or the project information associated with application content. For example, the context menu for each tab can offer actions, such as creating a project to associate with the tab, associating an existing project with the application content associated with the tab, opening related documents, marking the project/task as completed, changing the urgency/importance of the application content, and the like, in addition to the typical context menu actions (i.e. close tab, open tab in new window, duplicate tab, etc.). The tab context menu can be activated in the usual manner, e.g., by right clicking on a tab.

The project management system also provides real-time project synchronization capabilities. For example, the project management system can upload project information, including project name, documents and applications associated with projects, urgency/importance classifications, assigned tab colors, color-coding schemes, project snapshots, and other relevant project management information to a suitable online data store, cloud storage, or the like, and update this information as changes are detected within the browser window. In this way, project management information can be synchronized in real-time across devices to browser applications having the project management system and that have the same application content loaded in view ports in the browser.

The technical solutions provided herein provide automated visual cues that enable application content to be visually distinguished based on the visual characteristics of the tabs associated with the view ports in which the content is loaded. Tabs are highlighted based on the urgency level classification of the application content. The solutions also provide project snapshots and context menus for view ports which enable interactions with application content, projects, and/or project timelines without having to switch view ports in the main browser window. This integration minimizes the need for frequent context switching between view ports to find relevant project information, thus enhancing project management efficiency and productivity. Overall, the technical solutions described herein bridge the gap between browser view port/tab management and dedicated project management tools by offering a cohesive, integrated approach that enhances efficiency and effectiveness in enterprise project management scenarios.

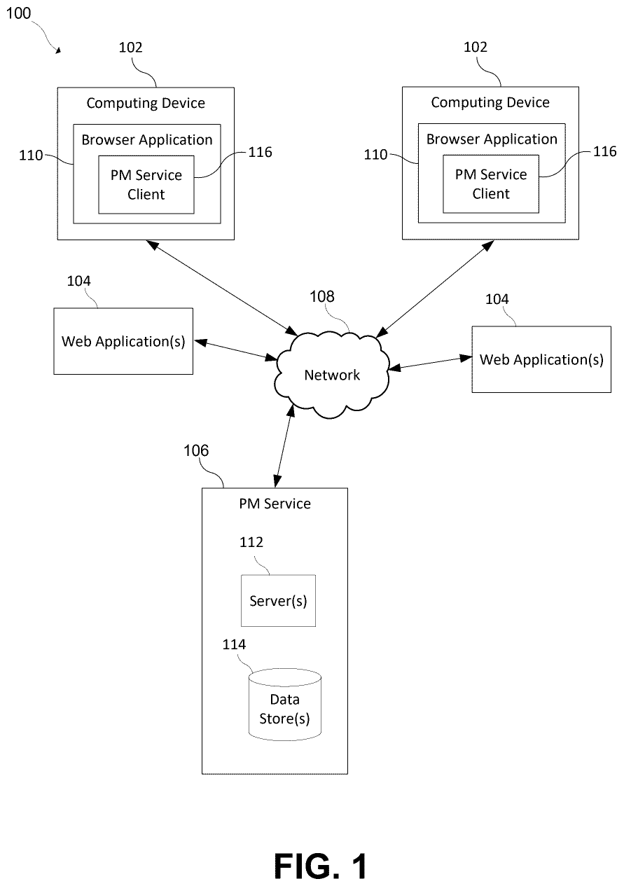

Referring now to the drawings, FIG. 1 illustrates an example computing environment 100 upon which aspects of the disclosure are implemented. Computing environment 100 includes user computing devices 102, web applications 104, and a project management (PM) service 106 which communicate with each other via a network 108. The network 108 includes one or more wired, wireless, and/or a combination of wired and wireless networks. The network 108 may include one or more local area networks (LAN), wide area networks (WAN) (e.g., the Internet), public networks, private networks, virtual networks, mesh networks, peer-to-peer networks, and/or other interconnected data paths across which multiple devices may communicate. In embodiments, the network 108 is coupled to or includes portions of a telecommunications network for sending data in a variety of different communication protocols. In some implementations, the network 108 includes Bluetooth® communication networks or a cellular communications network for sending and receiving data including via short messaging service (SMS), multimedia messaging service (MMS), hypertext transfer protocol (HTTP), direct data connection, WAP, email, and the like.

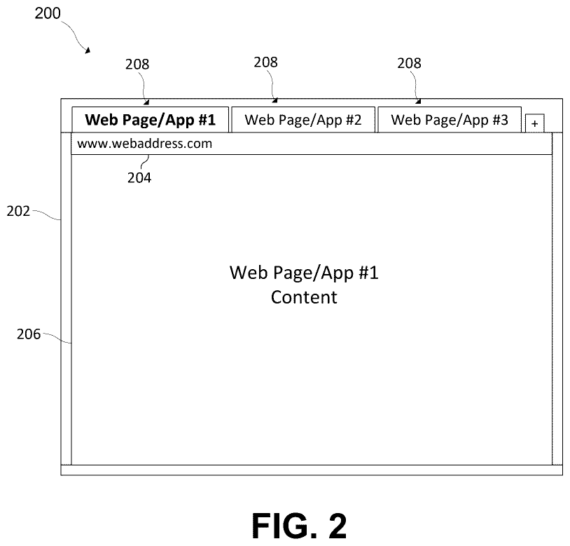

The computing devices 102 can be any suitable type of computing device, such as personal computers, desktop computers, laptop computers, mobile telephones, smart phones, tablets, phablets, smart watches, wearable computers, gaming devices/computers, televisions, and the like. Each computing device 102 includes at least one browser application 110 (also referred to as a “web browser”) that is executed on the computing device 102. The browser application 110 is a software application used to access and navigate the Internet. An example illustration of a user interface 200 of a browser application is shown in FIG. 2. The user interface 200 includes a main browser window 202 that has an address bar 204 and a web page display area 206. The address bar 204 is a text field typically located at the top of the browser window 202 where users can type or view a website's URL (Uniform Resource Locator). It serves as the interface for entering web addresses, allowing users to navigate directly to specific websites by typing the URL and pressing “Enter.” In addition to displaying URLs, the address bar 204 can often be used as a search bar, enabling users to enter search terms that will be processed by the browser's default search engine. The web page display area 206 corresponds to a view port and defines the visible area of the web page or application content associated with the address in the address bar 204. Browsers use protocols like HTTP and HTTPS to request web page content including text, images, videos, and other multimedia elements from web servers and render them in the web page display area in a user-friendly format.

The browser application enables the application content from different web pages, web applications, documents, and the like to be loaded into separate view ports in the browser application. The user interface 200 of the web browser includes a tab 208 for each of the view ports which has been opened in the browser application. Users can switch between view ports (and the application content loaded therein) by clicking on the tab of the view port that they want to view. Typically, one view port is active in the main browser window at a time, and the application content associated with the active view port is displayed in the web page display area. Clicking on a different tab causes the view port associated with that tab to become the active view port and be displayed in the web page display area 206.

In addition to accessing websites, the browser application 110 enables users to access web applications, such as web applications 104. Unlike traditional desktop applications, which are installed on a user's device, web applications 104 are accessed over the Internet and can be used on any device with a browser, regardless of operating system. They are designed to perform specific functions or tasks and may include dynamic and/or interactive elements. Web applications 104 rely on technologies like HTML, CSS, JavaScript, and server-side programming languages (e.g., PHP, Python, or Ruby) to provide an interactive, user-friendly experience. Examples of web applications include content creating/editing applications (e.g., word processors, presentation applications, etc.), productivity applications (e.g., calendar, task management, etc.), communication applications (e.g., messaging, email, chat, etc.), online shopping, social networking, banking, and the like.

As discussed above, web browsers are widely used for project management due to their ability to interact with web applications and load and switch between multiple documents and web applications in the same window. Previously known web browsers by nature introduced inefficiencies and reduced productivity when used for project management because previously known web browsers provided limited or no visual cues that enabled users to differentiate the different view ports and the application content loaded therein. Previously known web browsers in general do not have features that facilitate project management. To address the limitations of previously known browser applications, the present disclosure provides a PM service 106 and PM service client 116 which enable project management features, such as intelligent project/timeline classification of application content, enhanced visual differentiation of application content (or view port), project snapshots and tab context menus, and project information synchronization, to be integrated into the browser applications 110.

The PM service 106 includes at least one server 112 which is configured to provide computational and/or storage resources for implementing at least some of the functionality of the PM service 106. The server 112 is representative of any physical or virtual computing system, device, or collection thereof, such as, a web server, rack server, blade server, virtual machine server, or tower server, as well as any other type of computing system. In various implementations, the server 112 is implemented in a data center, a virtual data center, or some other suitable facility. Server 112 executes one or more software applications, modules, components, or collection thereof which interact with the PM service clients 116 to enable enhanced project management functionality in the browser applications 110. In various implementations, server 112 hosts data and/or content in connection with the PM service 106 and makes this data and/or content available to the users of client devices 106 via the network 110. Program code, instructions, user data and/or content for the PM service 106 is stored in a data store 114.

The browser applications 110 includes a PM service client 116 which enables the features and functionality provided by the PM service 106 to be integrated into the browser applications 110. The PM service client 116 is a software application, module, component, or collection thereof which is programmed to interact with the PM service 106. In one implementation, the PM service client 116 is implemented as an integral component of the browser application. In other implementations, the PM service client is implemented as an add-on or extension which is added to the browser application. The browser application 110, the PM service 106, and the PM service client 116 together provide a project management system that enhances the ability of the browser to perform project management tasks related to the application content loaded into the view ports of the browser relative to previously known browser applications.

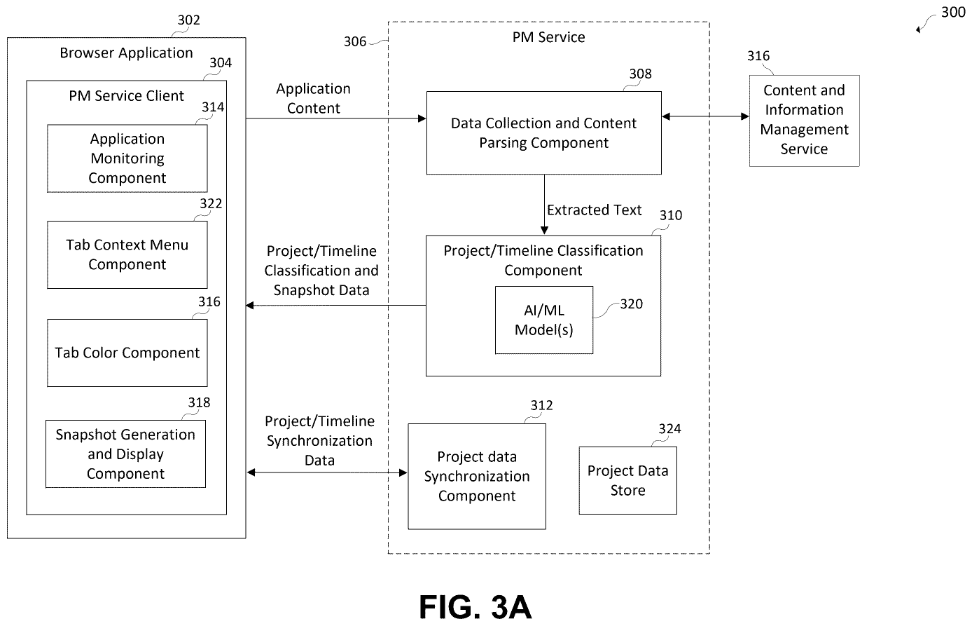

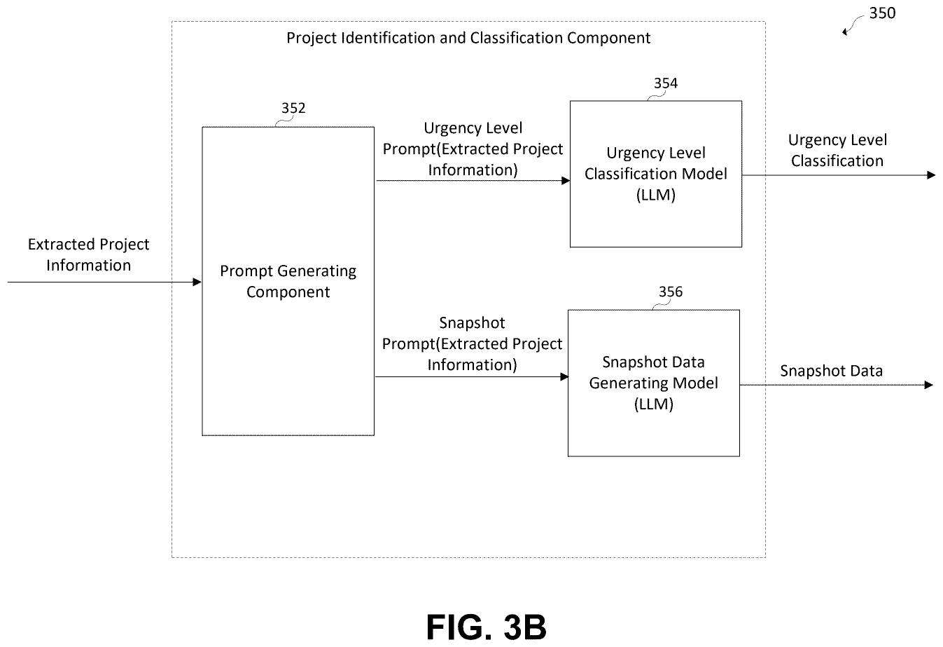

FIG. 3A shows an example computing environment 300 which shows example implementations of a browser application 302, a PM service client 304, and a PM service 306 that facilitate the performance of project management tasks in accordance with this disclosure. The PM service 306 includes a data collection and content parsing component 308, a project/timeline classification component 310, and a project data synchronization component 312. The data collection and content parsing component 308 receives application content of the view ports in the browser application from the PM service client 304. To this end, the PM service client 304 includes a application monitoring component 314 which monitors and collects data from each of the view ports in the browser application 302 and provides the application content to the data collection and content parsing component 308. The application content includes the text, metadata, application specific information, and other textual information pertaining to the application content.

The data collection and content parsing component 308 parses the application content to extract relevant information, such as dates, deadlines, milestones, and the like from the application content and to format the extracted textual content in a manner that is understandable by project/timeline classification component 310. In some implementations, the data collection and content parsing component 308 communicates with a content and information management service 316 to retrieve the application content loaded into the view ports of the browser application. The content and information management service 104 collects data information pertaining to the applications and documents accessed by users, including the user of the browser application 302. The content and information management service 104 facilitates the storage, organization, sharing, and managing of user information, application usage information, and document content. The content and information management service 104 includes an application programming interface (API) via which content of the documents loaded into the tabs of the browser application 302 can be retrieved. In collecting, storing, using and/or displaying any user data used in determining project classifications, care is taken to comply with privacy guidelines and regulations. For example, options may be provided to seek consent (e.g., opt-in) from users for collection and use of user data, to enable users to opt-out of data collection, and/or to allow users to view and/or correct collected data.

The relevant text extracted from the application content is provided to the project/timeline classification component 310 which analyzes the extracted text to identify project and timeline information pertaining to the application content and analyzes the project and timeline information to determine an urgency level classifications for the different application content. The urgency level classification is selected from a plurality of different predefined urgency level classifications (e.g., high, medium, low). To this end, the project/timeline classification component 310 includes at least one AI/ML model 320 that is trained to process project and timeline related text extracted from application content and to output an urgency level classification and snapshot information for application content. In various implementations, the AI/ML model 320 utilizes natural language processing (NLP) and/or named entity recognition (NER) techniques to process the extracted text to identify dates, durations, and other temporal expressions pertaining to projects and to understand the context in which these expressions appear in order to assess their significance and relevance to ongoing projects. In various implementations, the model 320 can comprise one or more Large Language Models (LLMs) which have been trained to analyze the extracted document text to project information, including timelines, deadlines, and the like. The project information for each project identified by the AI/ML model 320 is provided to the project classification model 320 which is trained to analyze project information related to timing and/or importance to determine a classification for the project (e.g., high, medium, or low urgency and/or high/critical importance, moderate importance, or low importance).

An example implementation of a project/timeline classification component 350 is shown in greater detail in FIG. 3B. The project/timeline classification component 350 includes a prompt generating component 352, a project/timeline classification model 354, and a snapshot generating model 356. The prompt generating component 352 receives the extracted text from the data collection and content parsing component and is configured to generate prompts for the project/timeline classification model 354 and the snapshot generating model 356 that includes the extracted text and other instructions for causing the project/timeline classification model 354 to output an urgency level classification and causing the snapshot generating component to generate snapshot data for the application content associated with the extracted text. The prompts are formatted and structured in a manner suitable for processing by the models. In various implementations, the project/timeline classification model 354 and the snapshot generating model 356 may comprise an LLM, such as GPT-3, GPT-4, ChatGPT, or the like, or other suitable generative AI/ML model. The urgency level classification and the snapshot data output by the project/timeline classification model 354 and the snapshot generating model 356, respectively, is provided to the PM service client 304 (FIG. 3A).

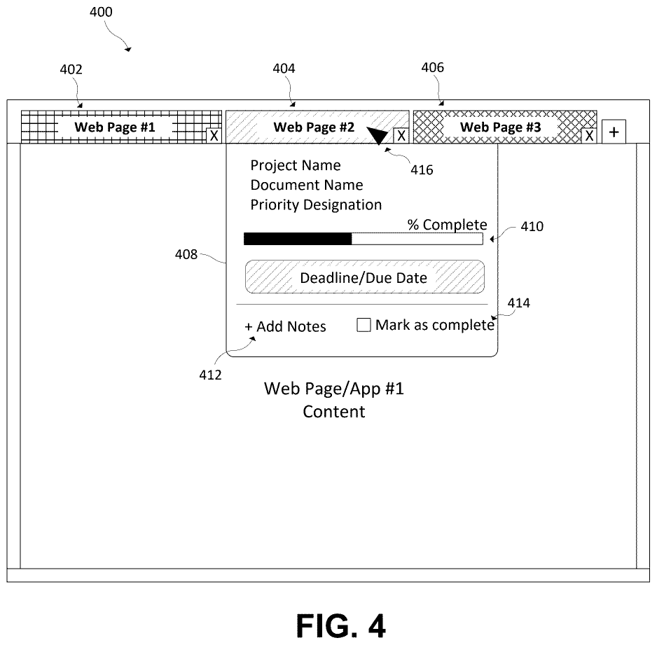

The urgency level classifications for the application content in the browser are used as the basis for coloring the tabs associated with the view ports for the application content. For example, tabs for view ports having application content which has been classified as high urgency, medium urgency, or low urgency are depicted or highlighted with different colors, e.g., a red color, a yellow color, and a green color, respectively. Any suitable coloring scheme can be utilized. In various implementations, more or fewer classification levels can be used. In some implementations, classifications can be based on importance level or other suitable criteria for differentiating application content. In the example implementation of FIG. 3A, the PM service client 304 includes a tab color component 316 which is programmed to modify tab colors based on urgency level classifications of application content. In some implementations, the PM service 306 and/or PM service client 304 enable users to customize various aspects of the tab coloring process, such as designating the colors to use with different classifications. FIG. 4 shows an example illustration of a browser application 400 in which the tabs 402, 404, 406 for different view ports have been depicted with different visual characteristics based on urgency level classifications of the application loaded in the view ports. In FIG. 4, different types of cross-hatching are used in the tabs to represent different tab colors. In some implementations, however, visual characteristics other than color, such as cross-hatching, can be used to indicate different classifications, such as shown in FIG. 4. The different colored tabs provide visual cues for differentiating and prioritizing project management tasks. For example, red colored tabs indicating high urgency/importance can be quickly and easily identified by a user so they can be handled appropriately. Users will know yellow and green colored tabs are associated with medium and low urgency tasks, respectively, which can be delayed if needed to perform high priority tasks.

The PM service client 304 includes a snapshot generation and display component 318 which generates project snapshots for the view ports based on the project snapshot information received from the PM service 306. As discussed above, a project snapshot is a pop-up window, dialog box, or other suitable type of user interface control which lists the project information for a project associated with a tab. FIG. 4 shows an example implementation of a project snapshot 408. In this example, the project snapshot 408 is for application content loaded in a view port associated with tab 404. The project snapshot 408 can list project information, such as project name, document name, the priority classification, the percent complete, and the deadline/due date which has been generated for the application content by the snapshot generating model 356. The project snapshot 408 includes a graphic 410 of the completion percentage. The project snapshot 408 also includes a control 412 for adding notes and a control 414 for marking the project/task as completed. Marking a project complete can change the urgency/importance level of the application content and result in a corresponding change in the color of the tab.

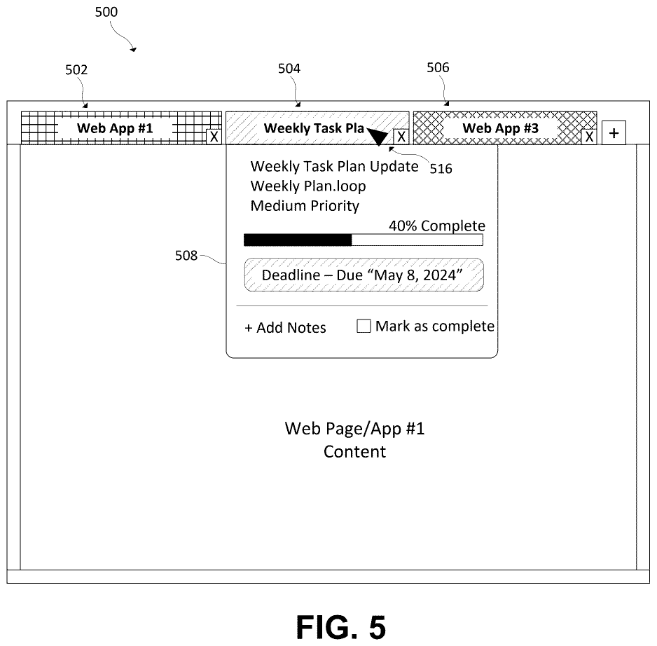

In various implementations, a project snapshot is displayed in response to detection of a mouseover, or hovering, event. In FIG. 4, the project snapshot 408 is displayed in response to a mouseover event, which in this case is the mouse pointer 416 hovering over the tab 404. The project snapshot 408 will be displayed until the mouse pointer 416 is moved away from the tab 404. As noted above, project snapshots provide ways to access and interact with project information without having to open the associated application content in the main browser window. FIG. 5 shows another example implementation of a project snapshot 508 that is similar to the example of FIG. 4 but includes names and values rather than placeholders to show how a project snapshot may actually appear. In FIG. 5, the browser application 500 includes tabs 502, 504, 506 which have been depicted with different cross-hatching which represent different colors. The project snapshot 508 is associated with the tab 504 and is displayed in response to the mouse pointer 516 hovering over the tab 504.

In various implementations, the PM service client 304 generates project snapshots using a predefined snapshot template which defines the general size and shape of the snapshot. A project snapshot is generated for each project tab based on the project snapshot template and is populated with project snapshot information received from the PM service 306. The snapshot generation and display component 318 monitors interactions with the browser application to detect mouseover events on tabs and causes project snapshots to be displayed near the appropriate tabs. Mouseover events can be detected in any suitable manner.

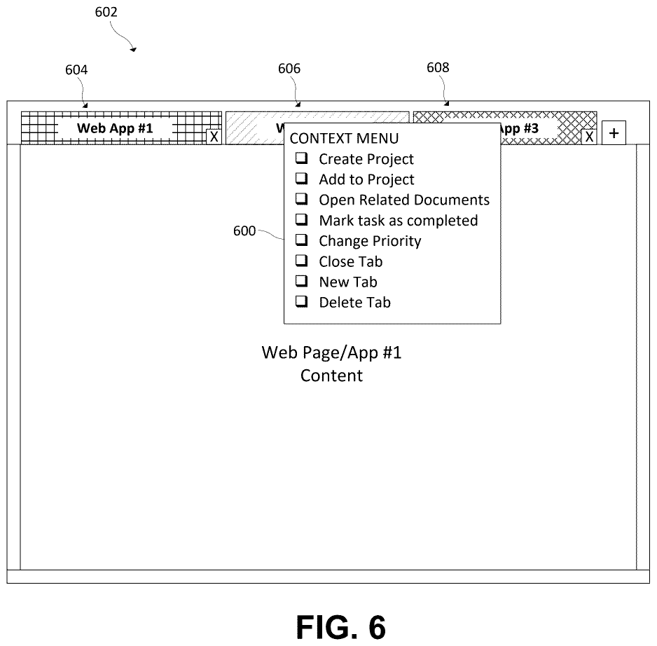

The PM service client 304 also includes a tab context menu component 322 which is used to generate a tab context menu for each tab that offers project management related actions. An example implementation of a tab context menu 600 is shown in FIG. 6. FIG. 6 depicts a browser application 602 having tabs 604, 606, 608. The tab context menu 600 is for the middle tab 606. The tab context menu includes project specific options, such as “create project” (e.g., to create a new project which the application content associated with the selected tab is to be associated with), “add to project” (e.g., to associate the application content with a pre-existing project), “open related documents” (for causing documents related to the application content to be opened in new tabs by the browser application), “mark task as completed”, and “change priority.” The context menu options shown in FIG. 6 are only examples of options which can be provided in a tab context menu. Any suitable project management related action can be included in the tab context menu 600. The tab context menu can be activated by clicking the right mouse button while the mouse pointer is positioned over the tab 606.

Returning to FIG. 3, the PM service 306 includes a project data service synchronization component 312 which enables project snapshot information, project/tab classifications, assigned tab colors, color-coding scheme used, and the like to be stored and synchronized to other computing devices which have at least one of the same documents opened a web browser and that have a PM service client integrated into the web browser. Changes that are made to project and snapshot information, such as priority, due date, and the like, pertaining to a document are provided to the project data synchronization component 312 as they are made. The project data synchronization component 312 then synchronizes (e.g., pushes) the project changes/updates to PM service clients in other browsers which have opened the same content. PM service clients therefore can update project snapshot information in real-time as the updated project data is received. In various implementations, the project data synchronization component 312 maintains project data in a project data store 324. The project data store 423 is an online data storage or cloud storage system. The project data synchronization component 312 can update this information as changes are made and this data can be synchronized to other PM service clients in real-time.

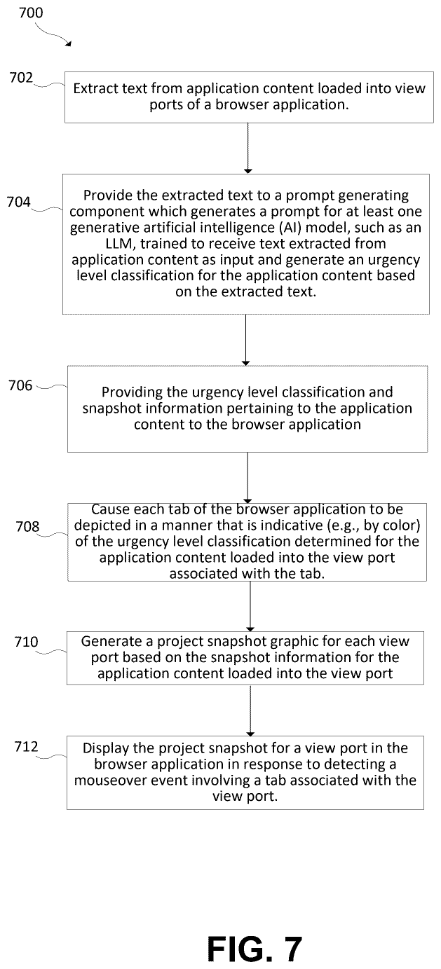

A flowchart of an example method 700 of enhancing the ability of browser applications to perform project management related tasks is shown in FIG. 7. The method begins with extracting text from application content loaded into view ports of a browser application (block 702). The extracted text is then provided to a prompt generating component which generates a prompt for at least one generative AI model, such as an LLM, trained to receive extracted from application content as input and output an urgency level classification for the application content based on the extracted text (block 704). Snapshot information pertaining to the application content can be generated in any suitable manner. For example, snapshot information can be generated by an AI/ML model which has been trained to analyze the extracted text to identify project and timeline information, such as project name, deadline, due date, and the like, in the extracted text. The urgency level classification and snapshot information are the application content is provided to the browser application (i.e., the PM service client of the browser application). Each of the tabs is then depicted in a manner that is indicative of the urgency level classification for the application content loaded into the view port associated with the tab (block 708). For example, different colors may be assigned to different urgency level classifications, and the tabs can be depicted with the color assigned to the corresponding urgency level classification. A project snapshot is generated for each view port based on the snapshot information for the application content loaded in the view port(block 710). The project snapshot for a view port is displayed in the browser application in response to detecting a mouseover event involving the tab associated with the view port (block 712).

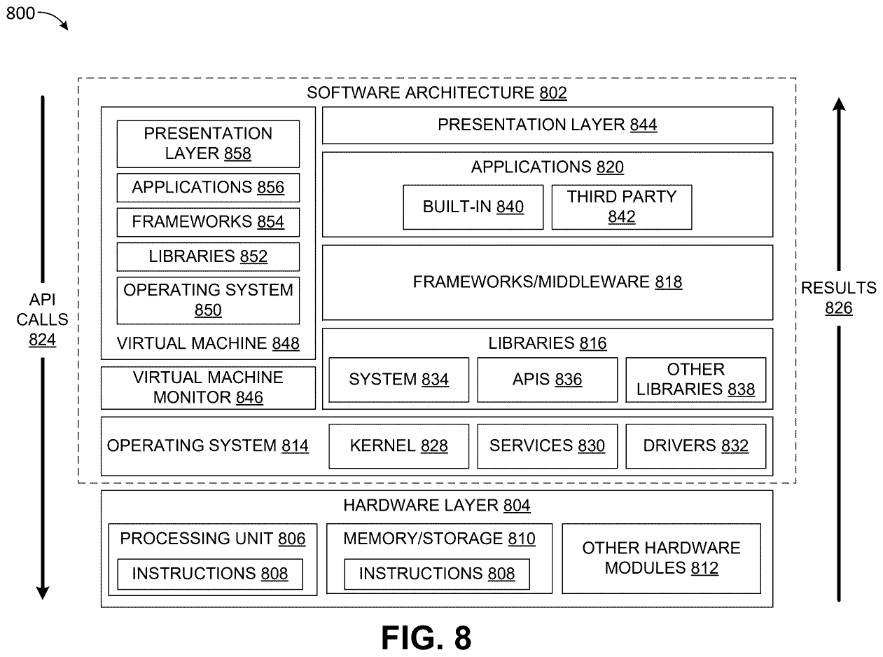

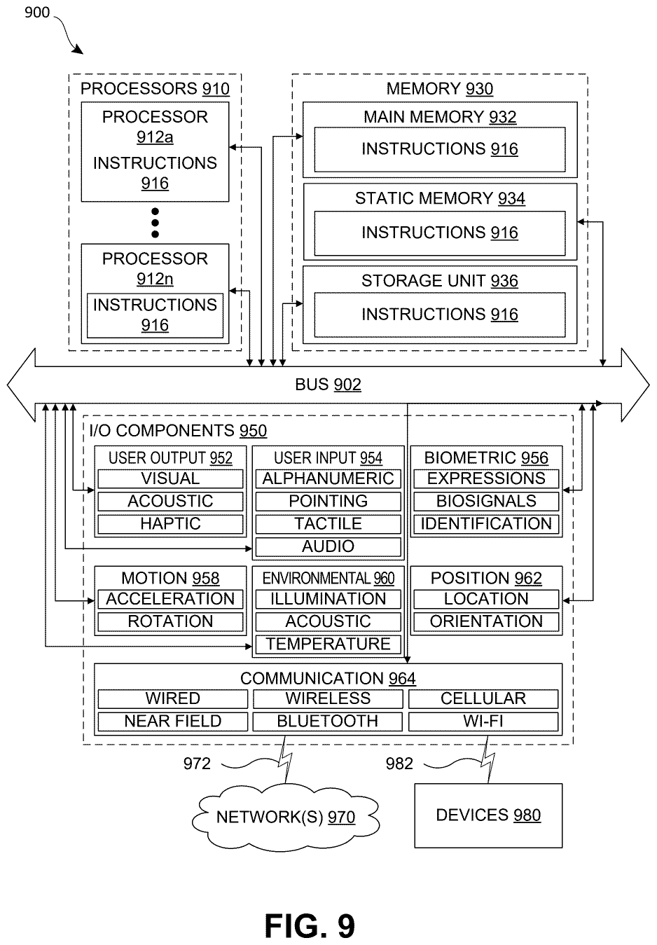

FIG. 8 is a block diagram 800 illustrating an example software architecture 802, various portions of which may be used in conjunction with various hardware architectures herein described, which may implement any of the above-described features. FIG. 8 is a non-limiting example of a software architecture, and it will be appreciated that many other architectures may be implemented to facilitate the functionality described herein. The software architecture 802 may execute on hardware such as a machine 900 of FIG. 9 that includes, among other things, processors 910, memory 930, and input/output (I/O) components 950. A representative hardware layer 804 is illustrated and can represent, for example, the machine 900 of FIG. 9. The representative hardware layer 804 includes a processing unit 806 and associated executable instructions 808. The executable instructions 808 represent executable instructions of the software architecture 802, including implementation of the methods, modules and so forth described herein. The hardware layer 804 also includes a memory/storage 810, which also includes the executable instructions 808 and accompanying data. The hardware layer 804 may also include other hardware modules 812. Instructions 808 held by processing unit 806 may be portions of instructions 808 held by the memory/storage 810.

The example software architecture 802 may be conceptualized as layers, each providing various functionality. For example, the software architecture 802 may include layers and components such as an operating system (OS) 814, libraries 816, frameworks 818, applications 820, and a presentation layer 844. Operationally, the applications 820 and/or other components within the layers may invoke API calls 824 to other layers and receive corresponding results 826. The layers illustrated are representative in nature and other software architectures may include additional or different layers. For example, some mobile or special purpose operating systems may not provide the frameworks/middleware 818.

The OS 814 may manage hardware resources and provide common services. The OS 814 may include, for example, a kernel 828, services 830, and drivers 832. The kernel 828 may act as an abstraction layer between the hardware layer 804 and other software layers. For example, the kernel 828 may be responsible for memory management, processor management (for example, scheduling), component management, networking, security settings, and so on. The services 830 may provide other common services for the other software layers. The drivers 832 may be responsible for controlling or interfacing with the underlying hardware layer 804. For instance, the drivers 832 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 816 may provide a common infrastructure that may be used by the applications 820 and/or other components and/or layers. The libraries 816 typically provide functionality for use by other software modules to perform tasks, rather than rather than interacting directly with the OS 814. The libraries 816 may include system libraries 834 (for example, C standard library) that may provide functions such as memory allocation, string manipulation, file operations. In addition, the libraries 816 may include API libraries 836 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 816 may also include a wide variety of other libraries 838 to provide many functions for applications 820 and other software modules.

The frameworks 818 (also sometimes referred to as middleware) provide a higher-level common infrastructure that may be used by the applications 820 and/or other software modules. For example, the frameworks 818 may provide various graphic user interface (GUI) functions, high-level resource management, or high-level location services. The frameworks 818 may provide a broad spectrum of other APIs for applications 820 and/or other software modules.

The applications 820 include built-in applications 840 and/or third-party applications 842. Examples of built-in applications 840 may include, but are not limited to, a contacts application, a browser application, a location application, a media application, a messaging application, and/or a game application. Third-party applications 842 may include any applications developed by an entity other than the vendor of the particular platform. The applications 820 may use functions available via OS 814, libraries 816, frameworks 818, and presentation layer 844 to create user interfaces to interact with users.

Some software architectures use virtual machines, as illustrated by a virtual machine 848. The virtual machine 848 provides an execution environment where applications/modules can execute as if they were executing on a hardware machine (such as the machine 900 of FIG. 9, for example). The virtual machine 848 may be hosted by a host OS (for example, OS 814) or hypervisor, and may have a virtual machine monitor 846 which manages operation of the virtual machine 848 and interoperation with the host operating system. A software architecture, which may be different from software architecture 802 outside of the virtual machine, executes within the virtual machine 848 such as an OS 850, libraries 852, frameworks 854, applications 856, and/or a presentation layer 858.

FIG. 9 is a block diagram illustrating components of an example machine 900 configured to read instructions from a machine-readable medium (for example, a machine-readable storage medium) and perform any of the features described herein. The example machine 900 is in a form of a computer system, within which instructions 916 (for example, in the form of software components) for causing the machine 900 to perform any of the features described herein may be executed. As such, the instructions 916 may be used to implement modules or components described herein. The instructions 916 cause unprogrammed and/or unconfigured machine 900 to operate as a particular machine configured to carry out the described features. The machine 900 may be configured to operate as a standalone device or may be coupled (for example, networked) to other machines. In a networked deployment, the machine 900 may operate in the capacity of a server machine or a client machine in a server-client network environment, or as a node in a peer-to-peer or distributed network environment. Machine 900 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 900 is illustrated, the term “machine” includes a collection of machines that individually or jointly execute the instructions 916.

The machine 900 may include processors 910, memory 930, and I/O components 950, which may be communicatively coupled via, for example, a bus 902. The bus 902 may include multiple buses coupling various elements of machine 900 via various bus technologies and protocols. In an example, the processors 910 (including, for example, a central processing unit (CPU), a graphics processing unit (GPU), a digital signal processor (DSP), an ASIC, or a suitable combination thereof) may include one or more processors 912a to 912n that may execute the instructions 916 and process data. In some examples, one or more processors 910 may execute instructions provided or identified by one or more other processors 910. The term “processor” includes a multi-core processor including cores that may execute instructions contemporaneously. Although FIG. 9 shows multiple processors, the machine 900 may include a single processor with a single core, a single processor with multiple cores (for example, a multi-core processor), multiple processors each with a single core, multiple processors each with multiple cores, or any combination thereof. In some examples, the machine 900 may include multiple processors distributed among multiple machines.

The memory/storage 930 may include a main memory 932, a static memory 934, or other memory, and a storage unit 936, both accessible to the processors 910 such as via the bus 902. The storage unit 936 and memory 932, 934 store instructions 916 embodying any one or more of the functions described herein. The memory/storage 930 may also store temporary, intermediate, and/or long-term data for processors 910. The instructions 916 may also reside, completely or partially, within the memory 932, 934, within the storage unit 936, within at least one of the processors 910 (for example, within a command buffer or cache memory), within memory at least one of I/O components 950, or any suitable combination thereof, during execution thereof. Accordingly, the memory 932, 934, the storage unit 936, memory in processors 910, and memory in I/O components 950 are examples of machine-readable media.

As used herein, “machine-readable medium” refers to a device able to temporarily or permanently store instructions and data that cause machine 900 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 916) for execution by a machine 900 such that the instructions, when executed by one or more processors 910 of the machine 900, cause the machine 900 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 950 may include a wide variety of hardware components adapted to receive input, provide output, produce output, transmit information, exchange information, capture measurements, and so on. The specific I/O components 950 included in a particular machine will depend on the type and/or function of the machine. For example, mobile devices such as mobile phones may include a touch input device, whereas a headless server or IoT device may not include such a touch input device. The particular examples of I/O components illustrated in FIG. 9 are in no way limiting, and other types of components may be included in machine 900. The grouping of I/O components 950 are merely for simplifying this discussion, and the grouping is in no way limiting. In various examples, the I/O components 950 may include user output components 952 and user input components 954. User output components 952 may include, for example, display components for displaying information (for example, a liquid crystal display (LCD) or a projector), acoustic components (for example, speakers), haptic components (for example, a vibratory motor or force-feedback device), and/or other signal generators. User input components 954 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 950 may include biometric components 956, motion components 958, environmental components 960, and/or position components 962, among a wide array of other physical sensor components. The biometric components 956 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 958 may include, for example, acceleration sensors (for example, an accelerometer) and rotation sensors (for example, a gyroscope). The environmental components 960 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 962 may include, for example, location sensors (for example, a Global Position System (GPS) receiver), altitude sensors (for example, an air pressure sensor from which altitude may be derived), and/or orientation sensors (for example, magnetometers).

The I/O components 950 may include communication components 964, implementing a wide variety of technologies operable to couple the machine 900 to network(s) 970 and/or device(s) 980 via respective communicative couplings 972 and 982. The communication components 964 may include one or more network interface components or other suitable devices to interface with the network(s) 970. The communication components 964 may include, for example, components adapted to provide wired communication, wireless communication, cellular communication, Near Field Communication (NFC), Bluetooth communication, Wi-Fi, and/or communication via other modalities. The device(s) 980 may include other machines or various peripheral devices (for example, coupled via USB).

In some examples, the communication components 964 may detect identifiers or include components adapted to detect identifiers. For example, the communication components 964 may include Radio Frequency Identification (RFID) tag readers, NFC detectors, optical sensors (for example, one-or multi-dimensional bar codes, or other optical codes), and/or acoustic detectors (for example, microphones to identify tagged audio signals). In some examples, location information may be determined based on information from the communication components 964, such as, but not limited to, geo-location via Internet Protocol (IP) address, location via Wi-Fi, cellular, NFC, Bluetooth, or other wireless station identification and/or signal triangulation.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system for integrating a project management system into a browser application, the data processing system comprising:
a processor; and
a memory in communication with the processor, the memory comprising executable instructions that, when executed by the processor alone or in combination with other processors, cause the data processing system to perform functions of:
extracting text from application content loaded into view ports of the browser application, the browser application including a tab for each of the view ports;
generating a prompt for an urgency level classification model, the urgency level classification model including a generative artificial intelligence (AI) model trained to receive the extracted text from the application content as input and to generate an urgency level classification for the application content based on the extracted text;
receiving the urgency level classification from the urgency level classification model;
generating snapshot information for the application content;
providing the urgency level classification and the snapshot information to the browser application; and
modifying a depiction of each tab of the browser application in a manner indicative of the urgency level classification for the application content loaded into a view port associated with the tab.

2. The data processing system of claim 1, wherein the executable instructions include instructions for causing the processor alone or in combination with other processors to further perform functions of:
generating a project snapshot for each view port based on the snapshot information for the application content, the project snapshot listing at least a name of a project associated with the application content, the urgency level classification for the application content, and timeline information for the application content; and
displaying the project snapshot in response to detecting a mouseover event involving the tab associated with the view port in which the application content is loaded.

3. The data processing system of claim 2, wherein the timeline information is derived from temporal information extracted from the application content.

4. The data processing system of claim 2, wherein the project snapshot includes at least one user interface control which, when activated, enables the snapshot information for the application content to be modified regardless of whether the view port in which the application content is loaded is currently displayed in the browser application.

5. The data processing system of claim 4, wherein the at least one user interface control comprises at least one of (i) a control which enables a note to be entered and added to the snapshot information for the application content associated with the snapshot information and (ii) a control which is activated to indicate that a project associated with the application content has been completed.

6. The data processing system of claim 1, wherein the executable instructions include instructions for causing the processor alone or in combination with other processors to further perform functions of:
generating a tab context menu for each of the tabs that lists at least one selectable project management action to perform with reference to the application content loaded into the view port associated with the tab.

7. The data processing system of claim 6, wherein the at least one selectable project management action comprises at least one of (i) opening related documents, (ii) adjusting the urgency level classification, and (iii) modifying a completion level.

8. The data processing system of claim 1, wherein the executable instructions include instructions for causing the processor alone or in combination with other processors to further perform functions of:
synchronizing the snapshot information and the urgency level classification determined for the application content loaded in the view ports of the browser application to other browser applications which have the application content opened therein.

9. A method for facilitating performance of project management tasks utilizing a browser application, the method comprising:
extracting text from application content loaded into view ports of the browser application, the browser application including a tab for each of the view ports;
generating a prompt for urgency level classification model, the urgency level classification model including a generative artificial intelligence (AI) model trained to receive the extracted text from the application content as input and to generate an urgency level classification for the application content based on the extracted text;
receiving the urgency level classification from the urgency level classification model;
generating snapshot information for the application content;
providing the urgency level classification and the snapshot information to the browser application; and
modifying a depiction of each tab of the browser application in a manner indicative of the urgency level classification for the application content loaded into a view port associated with the tab.

10. The method of claim 9, further comprising:
generating a project snapshot for each view port based on the snapshot information for the application content, the project snapshot listing at least a name of a project associated with the application content, the urgency level classification for the application content, and timeline information for the application content; and
displaying the project snapshot in response to detecting a mouseover event involving the tab associated with the view port in which the application content is loaded.

11. The method of claim 10, wherein the timeline information is derived from temporal information extracted from the application content.

12. The method of claim 11, wherein the project snapshot includes at least one user interface control which, when activated, enables the snapshot information for the application content to be modified regardless of whether the view port in which the application content is loaded is currently displayed in the browser application.

13. The method of claim 12, wherein the at least one user interface control comprises at least one of (i) a control which enables a note to be entered and added to the snapshot information for the application content associated with the snapshot information and (ii) a control which is activated to indicate that a project associated with the application content has been completed.

14. The method of claim 9, further comprising:
generating a tab context menu for each of the tabs that lists at least one selectable project management action to perform with reference to the application content loaded into the view port associated with the tab.

15. The method of claim 14, wherein the at least one selectable project management action comprises at least one of (i) opening related documents, (ii) adjusting the urgency level classification, and (iii) modifying a completion level.

16. The method of claim 9, further comprising:
synchronizing the snapshot information and the urgency level classification determined for the application content loaded in the view ports of the browser application to other browser applications which have the application content opened therein.

17. A non-transitory computer readable medium on which are stored instructions that, when executed, cause a programmable device to perform functions of:
extracting text from application content loaded into view ports of a browser application, the browser application including a tab for each of the view ports;
generating a prompt for urgency level classification model, the urgency level classification model including a generative artificial intelligence (AI) model trained to receive the extracted text from the application content as input and to generate an urgency level classification for the application content based on the extracted text;
receiving the urgency level classification from the urgency level classification model;
generating snapshot information for the application content;
providing the urgency level classification and the snapshot information to the browser application; and
modifying a depiction of each tab of the browser application in a manner indicative of the urgency level classification for the application content loaded into a view port associated with the tab.

18. The non-transitory computer readable medium of claim 17, wherein the functions further comprise:
generating a project snapshot for each view port based on the snapshot information for the application content, the project snapshot listing at least a name of a project associated with the application content, the urgency level classification for the application content, and timeline information for the application content; and
displaying the project snapshot in response to detecting a mouseover event involving the tab associated with the view port in which the application content is loaded.

19. The non-transitory computer readable medium of claim 18,, wherein the project snapshot includes at least one user interface control which, when activated, enables the snapshot information for the application content to be modified regardless of whether the view port in which the application content is loaded is currently displayed in the browser application.

20. The non-transitory computer readable medium of claim 17, wherein the functions further comprise:
generating a tab context menu for each of the tabs that lists at least one selectable project management action to perform with reference to the application content loaded into the view port associated with the tab.
